(19) United States
(12) Patent Application Publication
(10) Pub. No.: US 2007/0257497 A1
(43) Pub. Date: Nov. 8, 2007

(54) VEHICLE BUMPER BEAM CONSTRUCTED OF METAL AND PLASTIC

(76) Inventors: David W. Heatherington, Spring Lake, MI (US); Scott C. Glasgow, Spring Lake, MI (US); Bruce W. Lyons, Grand Haven, MI (US); Darin Evans, Spring Lake, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/614,294

(22) Filed: Dec. 21, 2006

Related U.S. Application Data
(60) Provisional application No. 60/754,079, filed on Dec. 27, 2005.

(51) Int. Cl. B60R 19/03

(52) U.S. Cl. 293/120

(57) ABSTRACT

A bumper system for a vehicle comprising a stamped metal component and a second polymeric component fixedly attached to form a beam with particular localized energy absorber characteristics. The metal component is formed from a sheet and has a thickness in a width direction along a majority of the length when in a vehicle-mounted position. The second polymeric component engages a face of the first component and is rigidly attached to the first component in at least several locations along the length to form a structural beam with the first component. The second polymeric component has sufficient structure to form an integral part of the structural beam and interconnected walls extending in the width direction to form energy-absorbing cells at centered and corner locations configured to crush and absorb energy upon a vehicle impact.

### CROSS-REFERENCE TO RELATED APPLICATION

This application claims priority to U.S. Provisional Patent Application No. 60/754,079 entitled VEHICLE BUMPER BEAM CONSTRUCTED OF METAL AND PLASTIC, which was filed on Dec. 27, 2005.

### BACKGROUND

The present invention relates to a beam design that absorbs energy efficiently while deforming during an impact. Applications for this invention could include vehicle bumper systems, side impact bars, instrument panel cross-car substructures, and sill plates.

Modern impact beams are designed to absorb a maximum of impact energy over a given stroke. At the same time, they are designed to minimize load spikes, and to distribute energy in a manner promoting uniform and predictable collapse upon undergoing loading from impact. Further, the individual components of an energy absorbing system must combine well with other energy absorbing components.

In particular, improvements are desired to better integrate components of bumper systems for passenger vehicles. For example, many “traditional” modern vehicle bumper systems include a very rigid, structural metal beam attached either directly to and between vehicle frame rails or in combination with intermediate rail extension brackets to position and adapt the bumper systems appropriately for various packaging conditions. Typically, a polymeric energy absorber is placed on a face of the metal beam to fill the space between the beam and the outer face or styled appearance surface and provide additional energy management capacity to the combined system. The rigid structural metal beam is intended to provide the primary energy absorbing structure, while the polymeric energy absorber is configured to crush and absorb energy (and also distribute stress) during an initial impact. However, it is not easy to tune the metal beam for specific localized impact absorption characteristics along different sections of the metal beam for optimal system performance. Since the metal beam is intended to be the primary energy absorbing structure, it is often “over designed” to meet the minimum strength and structure required along the beam, which results in many longitudinal sections being stronger and heavier than they need to be. Furthermore, some economical manufacturing processes, such as roll-forming, require constant sections and constant material thicknesses, which makes local tuning of the structure difficult. This is not good for several reasons. First, the longitudinal sections that are stronger than they need to be are concurrently heavier than they need to be. Further, sections that are “too strong” may in fact cause impact energy to be prematurely communicated to the vehicle frame, resulting in damage to the vehicle body that could otherwise be avoided. Yet another reason is related to space consumed by the bumper system. Structural metal beams take up “package” space, which reduces the space available for other things or which forces the vehicle designer to design a larger vehicle with less styling flexibility than is desired. Still further, structural metal beams traditionally present a large and relatively flat front surface adapted to engage and support the softer plastic energy absorber, which is necessary for good crush characteristics of the energy absorber. However, the existence of a large front surface on the metal structural beam means that frame mounts on a rear of the metal structural beam must be formed by separately attached secondary components (e.g. stamped brackets welded to the metal beam) or formed by surfaces formed by secondary operations (e.g. drilling, cutting, welding and/or deforming operations on end sections of the metal beam). Secondary components and operations are expensive, time consuming, and add undesirably to manufacturing costs and quality control difficulties.

Accordingly, a bumper system is desired solving the aforementioned problems and having the aforementioned advantages.

### SUMMARY OF THE PRESENT INVENTION

An aspect of the present invention is to provide a bumper system for a vehicle comprising a metal component and a second component. The metal component has a length and opposing ends adapted for attachment to frame rails of a vehicle frame. The second component engages a face of the metal component and is rigidly attached to the metal component continuously along a common interface or at least at several locations along this interface to form a structural beam with the metal component. The second component comprises a polymeric material and has sufficient structure to form an integral part of the structural beam. The polymeric component is also designed with interconnected walls extending in a transverse width direction to form energy-absorbing cells configured to crush and absorb energy upon a vehicle impact.

Another aspect of the present invention is to provide a bumper system for a vehicle comprising a first component and a second component. The first component has a length and opposing ends adapted for attachment to frame rails of a vehicle frame. The second component engages a face of the first component and is rigidly attached to the first component to form a structural beam with the stamped component. The second component is molded from material comprising a polymer and has energy-absorbing cells configured to crush and absorb energy upon a vehicle impact, whereby a need for a separate energy absorber on a face of the structural beam is substantially avoided.

Yet another aspect of the present invention is to provide a bumper system for a vehicle comprising a metal component and a polymeric component. The metal component is formed from a sheet of material and has a length sufficient to and adapted to extend between spaced-apart frame rails of a vehicle. The metal component characteristically not having good bending strength in a forward direction as a stand-alone component due to a relatively flat geometry of the metal component, such that the metal component is unable to function as a bumper reinforcement beam by itself. The polymeric component has a length about equal to the metal component and being fixedly attached to the metal component either continuously or at multiple locations to form a self-supporting rigid structural bumper reinforcement beam that resists bending. The polymeric component includes a plurality of integrally-formed forwardly-extending energy-absorbing sections configured to crush and absorb energy upon receiving an impact.

Another aspect of the present invention is to provide a method of making a bumper system. The method includes forming a first component of a first material and forming a second component of a second material, with the first material and the second material being different. The method also includes engaging the second component with a face of the first component and rigidly attaching the second component to the first component in at least several locations along the length to form a structural beam with the first component. The method further includes providing the second component with sufficient structure to form an integral part of the structural beam but also having interconnected walls extending in the width direction to form energy-absorbing cells configured to crush and absorb energy upon a vehicle impact.

Accordingly, another aspect of the present invention includes providing a bumper system for a passenger vehicle comprising a metal component having opposing ends with rearwardly-facing mounting surfaces adapted for attachment to frame rails of a vehicle frame; a second component comprising a polymer positioned in front of the metal component and extending at least a length of the metal component; the metal and second components including front and rear walls, respectively, that are fixedly secured together along top and bottom edges to form a unitary beam that is sufficient in length to extend between the rails, the front and rear walls of the unitary beam forming a tubular shape along at least one transverse cross section; and the second component further having stiffening ribs that extend into a concavity defined by the unitary beam proximate the at least one transverse cross section.

Another aspect of the present invention is to provide a bumper system of the previous paragraph having any of the following features: wherein the concavity is defined at least in part by the metal component, wherein the mounting surfaces are coplanar; wherein the second component further includes an array of interconnected walls forming a crush box for providing corner impact strength at locations outboard of the opposing ends of the metal component; wherein the second component further includes an array of interconnected walls forming a structural corner and bumper shape at locations outboard of the opposing ends of the metal component; wherein the second component includes varied wall thicknesses for tuned localized energy absorption; wherein the second component is injection molded; wherein the second component includes integrally formed attachment members for connecting the plastic component to the metal component; wherein the second component is insert-molded onto the metal component; wherein the metal component is stamped; wherein attachment of the second component and the metal component along the top and bottom is mechanical; wherein the top and bottom edges include overlapping members (and possibly wherein the overlapping members include abutting surfaces that extend horizontally when in a vehicle-mounted position or the overlapping members include abutting surfaces that extend vertically when in a vehicle-mounted position); or wherein the top and bottom edges of the second component define a recess for receiving attachment flanges of the metal component along the top and bottom edges.

Yet another aspect of the present invention is to provide a bumper system for a passenger vehicle comprising a metal component having opposing ends with mounting surfaces configured and adapted for attachment to frame rails of a vehicle frame; and a second component comprising a polymeric material positioned on a face of the metal component and extending at least a length of the metal component; the metal and second components including front and rear walls that are fixedly secured together along top and bottom edges to form a unitary beam, the unitary beam being tubular along at least one transverse cross section and being sufficient in length to extend between the rails; and the second component further having corner-forming end sections that extend beyond the mounting surfaces of the metal component, the corner-forming end sections including at least one array of interconnected ribs adapted and configured to absorb energy upon the passenger vehicle undergoing a corner impact.

Another aspect of the present invention is to provide a bumper system for a passenger vehicle comprising a metal component having opposing ends defining vehicle-facing mounting surfaces configured and adapted for attachment to frame rails of a vehicle frame; and a second component comprising a polymer positioned in front of the metal component; the metal and second components including front and rear walls that are fixedly secured together along top and bottom edges to form a unitary beam sufficient in length to extend between the rails; and the second component further having integral corner-forming end sections that extend beyond the metal component and that have outwardly-facing surfaces adapted to define corners of the vehicle.

Yet another aspect of the present invention is to provide a bumper system of the previous paragraph having any of the following features: wherein surfaces of the end sections are adapted to support fascia on the vehicle; or wherein surfaces of the end sections and a center outer surface of the second component define a curvilinear shape with the surfaces of the end sections being angled more rearwardly than outer portions of the center outer surface.

Another aspect of the present invention is to provide a bumper system for a passenger vehicle comprising a metal component having opposing ends defining vehicle-facing mounting surfaces configured and adapted for attachment to frame rails of a vehicle frame; and a second component comprising a polymer positioned on a face of the metal component; the metal and second components including front and rear walls that are fixedly secured together along top and bottom edges to form a unitary beam sufficient in length to extend between the rails; and the second component further having integral corner-forming end sections that extend beyond the metal component and that have front surfaces adapted to define corners of the vehicle.

Yet another aspect of the present invention is to provide a bumper system for a passenger vehicle comprising a metal component having opposing ends defining vehicle-facing mounting surfaces configured and adapted for attachment to frame rails of a vehicle frame; and a second component comprising a polymer positioned on a face of the metal component; the metal and polymeric components including front and rear walls that are fixedly secured together along top and bottom edges to form a unitary beam sufficient in length to extend between the rails; and the second component further having top and bottom walls and having reinforcement walls extending between the top and bottom walls, the reinforcement walls being located and arranged to provide different energy absorption characteristics along a center section and along corner sections of the second component.

Yet another aspect of the present invention is to provide a bumper system of the previous paragraph having any of the following features: wherein thicknesses of the front, top, bottom and reinforcement walls are tuned to different thickness dimensions to achieve desired amounts of energy absorption; wherein the walls are each located along a plane, with the planes of the two walls not being co-planar; or wherein reinforcement walls in the center section have a rear edge spaced from the rear wall to create a sequential and increasing energy absorption profile during impact.

Another aspect of the present invention is to provide a bumper system for a passenger vehicle comprising a stamped metal component with coplanar mounting surfaces configured and adapted for attachment to frame rails of a vehicle frame; and an injection-molded component comprising a polymer engaging a face of the metal component; the injection-molded and metal components including front and rear walls that are fixedly secured together along top and bottom edges to form a unitary beam sufficient in length to extend between the rails; and the injection-molded component further having integrally-formed portions that fit at least partially into the stamped metal component for providing additional strength to the beam along predetermined longitudinal sections of the beam.

Yet another aspect of the present invention is to provide a bumper system of the previous paragraph having any of the following features: wherein the integrally-formed portions that fit into the stamped metal component include energy-absorbing rib arrays that have a rear surface spaced from the rear wall of the stamped metal component.

Another aspect of the present invention is to provide a bumper system for a passenger vehicle comprising a stamped metal component with coplanar mounting surfaces configured and adapted for attachment to frame rails of a vehicle frame; and an injection-molded component comprising a polymer engaging a face of the metal component; the injection-molded and metal components including front and rear walls with top and bottom edges that are fixedly secured together to form a unitary beam sufficient in length to extend between the rails; the top and bottom edges of the metal component including a plurality of apertures and the top and bottom edges of the injection-molded component including integrally-formed projections that extend through the apertures and that terminate in enlarged head sections fixedly securing the projections to the apertures.

Yet another aspect of the present invention is to provide a bumper system for a passenger vehicle comprising a stamped metal component with coplanar mounting surfaces configured and adapted for attachment to frame rails of a vehicle frame; and an injection-molded component comprising a polymer engaging a face of the metal component; the injection-molded and metal components including front and rear walls with top and bottom edges that are fixedly secured together to form a unitary beam sufficient in length to extend between the rails; the top and bottom edges of the metal component including a plurality of apertures and the top and bottom edges of the injection-molded component including integrally-formed projections that extend through the apertures and that terminate in enlarged head sections fixedly securing the projections in the apertures.

Another aspect of the present invention is to provide a bumper system for a passenger vehicle comprising a stamped metal component with coplanar mounting surfaces configured and adapted for attachment to frame rails of a vehicle frame; and an injection-molded component comprising a polymer engaging a face of the metal component; the injection-molded and metal components including front and rear walls, respectively, with top and bottom edges that overlap and that are fixedly secured together to form a unitary beam sufficient in length to extend between the rails; the top and bottom edges of the injection-molded component capturing the top and bottom edges of the metal component so that upon impact, the top and bottom edges of the metal component are captured and cannot spread, such that the unitary beam thus formed has an increased strength resisting premature kinking and collapse during impact.

These and other aspects, objects, and features of the present invention will be understood and appreciated by those skilled in the art upon studying the following specification, claims, and appended drawings.

### BRIEF DESCRIPTION OF DRAWINGS

FIG. 1 is a top view of a bumper system of the present invention.

FIG. 2 is a rear perspective view of the bumper beam of the present invention.

FIG. 3 is a front perspective view of the bumper beam of the present invention.

FIG. 4 is a rear perspective view of the bumper beam of the present invention with a first component of the bumper beam partially removed.

FIG. 5 is a rear view of a first component of the bumper beam of the present invention.

FIG. 6 is a front view of the first component of the bumper beam of the present invention.

FIG. 7 is a rear view of a second component of the bumper beam of the present invention.

FIG. 8 is a front view of the second component of the bumper beam of the present invention.

FIGS. 9-9F are vertical cross sections showing various beam embodiments, including various overlapping attachment arrangements.

FIG. 10 is a perspective view showing a modified bumper system with a stamped rear metal component and an injection-molded polymeric front component, the polymeric front component having a plurality of differently-shaped reinforcement rib arrays forming energy absorbing sections with tuned energy absorption characteristics as shown in FIGS. 10A and 10B.

FIG. 11 is a schematic side view of a molding process for making the bumper system of FIG. 10, where the metal component is positioned within molding dies of an injection mold for insert molding the polymeric component onto the metal component.

FIG. 12 is a schematic top view of an alternative modified bumper system having a vehicle-engaging metal component and an outer polymeric component attached to the metal component to form a beam, the polymeric component having interconnected arrays of ribs forming center, intermediate, and corner-forming crush boxes, each specifically designed for particular crush characteristics at their respective locations along the center, mounts, and corners of the bumper system.

### DETAILED DESCRIPTION OF PREFERRED EMBODIMENTS

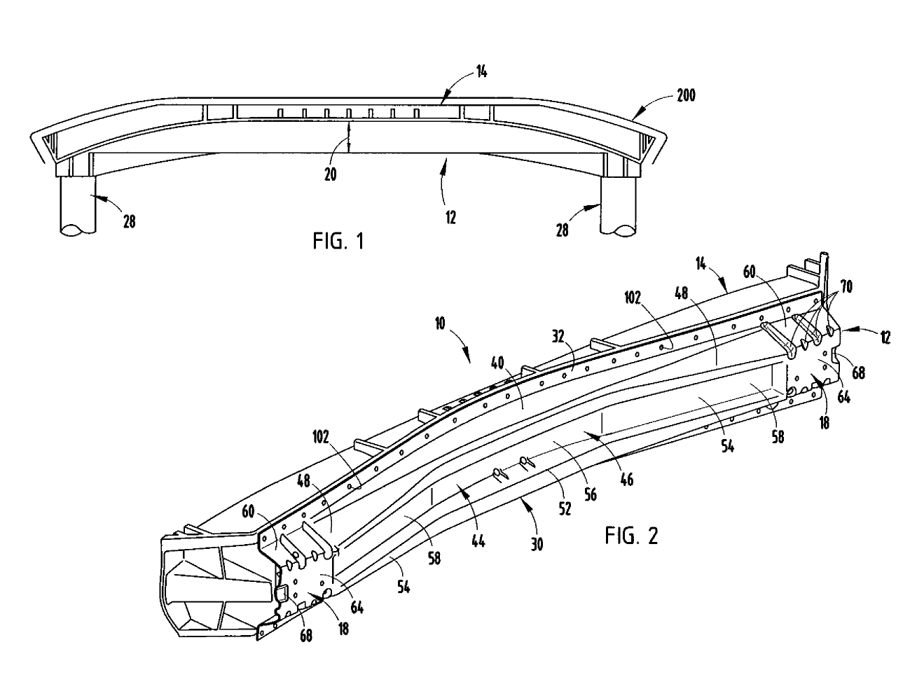

For purposes of description herein, the terms “upper,” “lower,” “right,” “left,” “rear,” “front,” “vertical,” “horizontal,” and derivatives thereof shall relate to the invention as orientated in FIG. 1. However, it is to be understood that the invention may assume various alternative orientations. In particular, the words “front” and “rear” are intended to be used herein for convenience and for understandability in the present description and claims, but it is intended that these terms are to be interpreted to be equally applicable to bumper systems used on a forward end or a rearward end of a vehicle. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

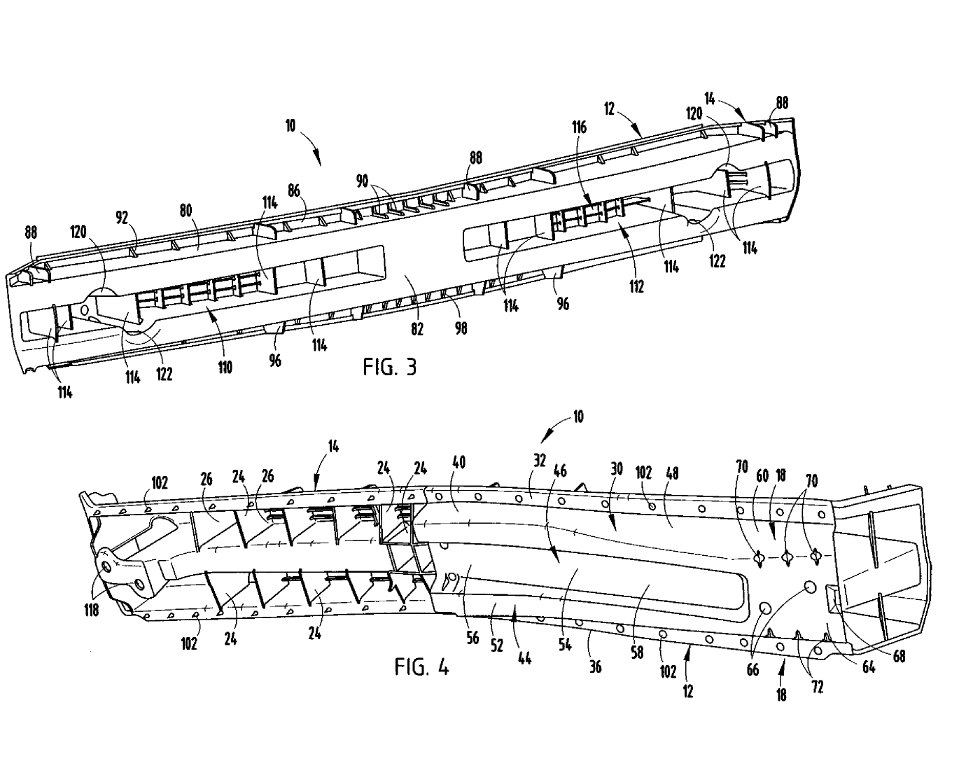

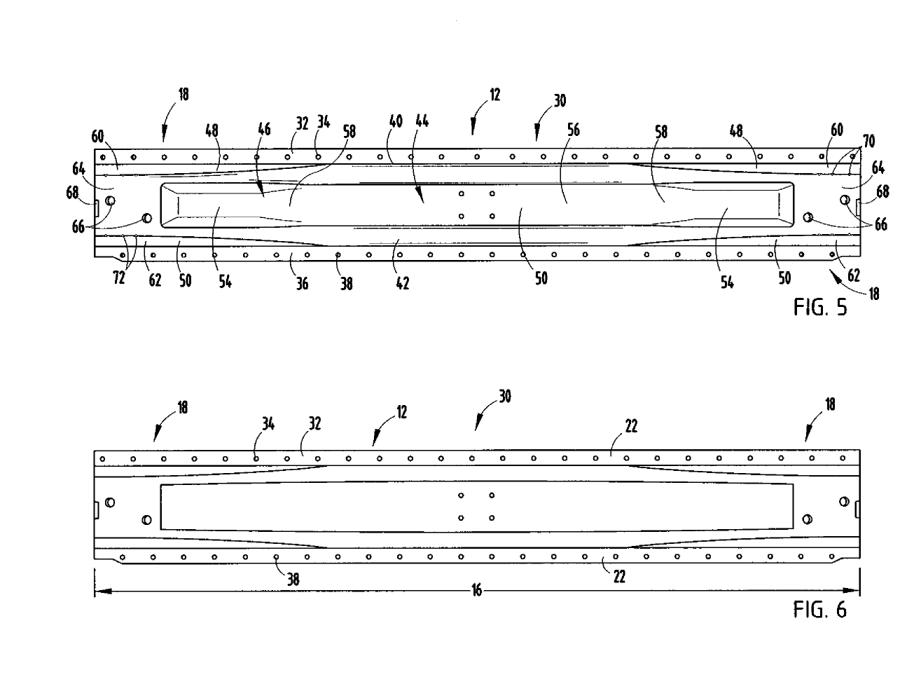

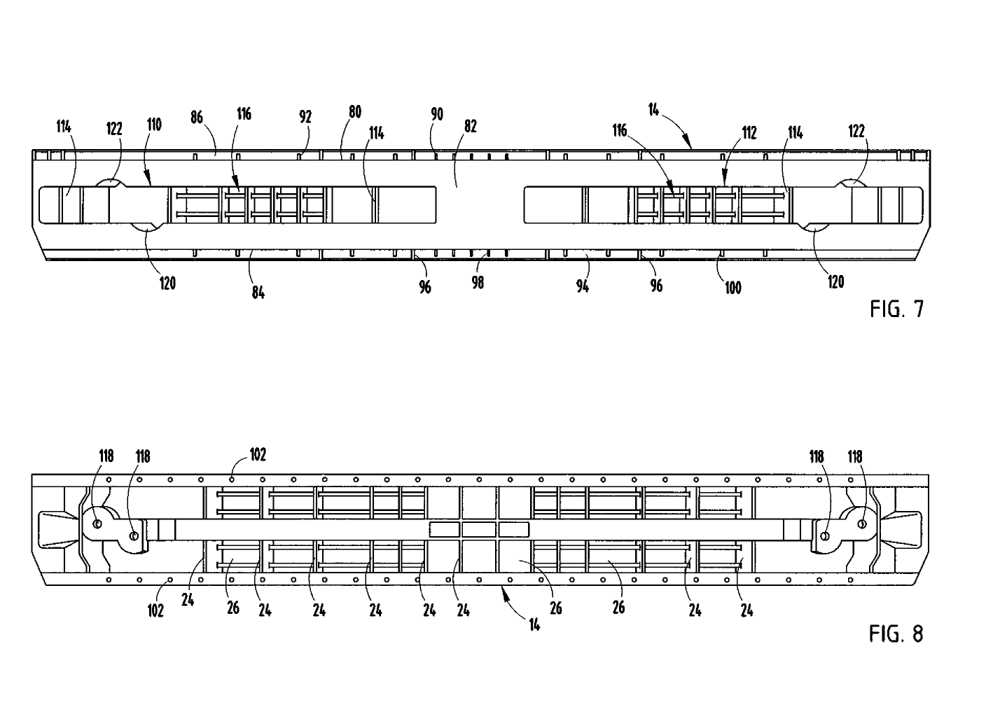

The reference number 10 (FIGS. 1-4) generally designates a bumper system for a vehicle according to the present invention. In the illustrated example, the bumper system 10 comprises a first component 12 and a second polymeric component 14. The first component 12 has a length 16 (see FIG. 6) and opposing ends 18 adapted for attachment to frame rails 28 of a vehicle frame. The first component 12 is formed from a sheet and has a thickness 20 in a width direction along a majority of the length 16 when in a vehicle-mounted position. The second polymeric component 14 engages a face 22 of the first component 12 and is rigidly attached to the first component 12 in at least several locations along the length to form a structural beam with the first component 12. The second polymeric component 14 has sufficient structure to form an integral part of the structural beam and interconnected walls 24 extending in the width direction to form energy-absorbing cells 26 configured to crush and absorb energy upon a vehicle impact. The moment of inertia and strength of the system is balanced and optimized by considering the geometric shape and material strength of each component, thus developing a true monocoque hybrid structure. The strength and robustness of the attachment between the two components is preferably sufficient to transfer load effectively across the interfaces and maintain the integrity of the structure during a high deformation event. This allows the new hybrid system to perform the energy management functions of what previously required two or more separate components.

In the illustrated embodiment, the first component 12 is stamped from a sheet of material having a single thickness. Preferably, the first component 12 is made from steel. For example, the first component 12 can be made from a dual phase 980 MPa ultra high strength steel. However, it is contemplated that the first component 12 could be made of any material having properties similar to steel. Furthermore, the first component 12 preferably has a yield strength of greater than 80 KSI, and most preferably has a yield strength of greater than 170 KSI. Moreover, the first component 12 has a greater height dimension and length dimension than depth dimension. The first component 12 includes the opposing ends 18 adapted for attachment to the frame rails 28 of a vehicle frame. The first component 12 also includes a middle section 30 extending between the opposing ends 18. The first component 12 further includes a top flange 32 having top apertures 34 therethrough and a bottom flange 36 having bottom apertures 38 therethrough extend along the length 16 of the first component 12.

The illustrated middle section 30 of the first component 12 has a substantially C-shaped cross section, extends between the opposing ends 18 of the first component 12 and is connected to second polymeric component 14. The middle section 30 includes a top surface 40, a bottom surface 42 and a rear surface 44 having a longitudinal channel 46 therein. The top surface 40 is connected to the top flange 32 and extends downwardly away from the top flange 32 towards the rear surface 44. The top surface 40 also includes triangular angled portions 48 at each end thereof. The bottom surface 42 is substantially a mirror image of the top surface 40 and is connected to the bottom flange 36 and includes triangular angled portions 50 at each end thereof. The rear surface 44 of the first component 12 includes a middle section 52 and a pair of end sections 54 extending away from the middle section 52 at a small angle. The longitudinal channel 46 is located in the middle section 52 and the end sections 54, with the longitudinal channel 46 having a deepest area 56 substantially parallel with the middle section 52 of the rear surface 44 and a pair of end areas 58 that are located in the end sections 54 of the rear surface 44 and that get progressively shallower as the channel 46 approaches the opposing ends 18 of the first component 12.

In the illustrated example, the opposing ends 18 of the first component 12 are adapted for attachment to frame rails 28 of a vehicle frame. The ends 18 are C-shaped and include a top surface 60 connected to the top surface 40 of the middle section 30, a bottom surface 62 connected to the bottom surface 42 of the middle section 30 and a rear connection face 64 between the top surface 60 and the bottom surface 62 of the ends 18. The rear connection face 64 includes a plurality of openings 66 therethrough for accepting fasteners to connect the rear connection face 64 and thereby the bumper system 10 of the frame rails 28. The rear connection face 64 also includes a notch 68 along an end edge thereof. In the illustrated embodiment, the ends 18 include three upper grooves 70 at the intersection of the top surface 60 and the rear connection face 64 and three lower grooves 72 at the intersection of the bottom surface 62 and the rear connection face 64.

The illustrated second polymeric component 14 is connected to the first component 12. Preferably, the second polymeric component 14 is made from an injection molded engineering-grade polymeric material. For example, the second polymeric component 14 can be made from an injection molded plastic. Furthermore, the second polymeric component can be made from blends of thermoplastic such as polycarbonate (PC) and polyester (e.g., PBT and PET). However, it is contemplated that the second polymeric component 14 could be made of any polymeric material and could include non-polymeric portions (e.g., a carbon fiber molded at least partially surrounded by the polymeric material). Furthermore, the first component 12 preferably has a yield strength of greater than 80 KSI, and most preferably has a yield strength of greater than 170 KSI.

In the illustrated example, the second polymeric component 14 includes a top wall 80, a front wall 82 and a bottom wall 84. In the illustrated embodiment, the top wall 80 and the bottom wall 84 are substantially parallel. The top wall 80 has an upstanding flange 86 along the edge adjacent the first component 12 and two opposite side edges. The top wall 80 also includes a plurality of large ribs 88, a plurality of mid-sized ribs 90 and a plurality of small ribs 92 extending upwardly therefrom and connected to the upstanding flange 86. Likewise, the bottom wall 84 has a downwardly depending flange 94 along the edge adjacent the first component 12 and two opposite side edges. The bottom wall 84 also includes a plurality of large ribs 96, a plurality of mid-sized ribs 98 and a plurality of small ribs 100 extending downwardly therefrom and connected to the downwardly depending flange 94. In the illustrated embodiment, the upstanding flange 86 and the downwardly depending flange 94 are connected to the top flange 32 and the bottom flange 36, respectively, of the first component 12. In a preferred embodiment, the upstanding flange 86 and the downwardly depending flange 94 each include a plurality of fasteners 102 extending through the top apertures 34 of the top flange 32 and the bottom apertures 38 of the bottom flange 36, respectively, of the first component 12. In the illustrated embodiment, the plurality of fasteners 102 comprise integrally formed protrusions extending from the upstanding flange 86 and the downwardly depending flange 94, wherein the protrusions include heat staked heads. Alternatively, or in addition to the protrusions, an adhesive can be used to connect the first component 12 to the second polymeric component 14. Furthermore, the fasteners 102 could comprise rivets. Nevertheless, it is contemplated that the first component 12 and the second component 14 could be connected in any manner. For example, the first component 12 or the second component 14 could include a pair of facing U-shaped flanges and the other of the first component 12 and the second component 14 could be slid onto the component with the U-shaped flanges.

The illustrated front wall 82 of the second polymeric component 14 includes a first side channel 110 and a second side channel 112. The first side channel 110 and the second side channel 112 each have a substantially C-shaped cross section with five parallel walls 114 extending between a top and a bottom of each of the first side channel 110 and the second side channel 112. Furthermore, each of the first side channel 110 and the second side channel 112 include a grid shaped wall section 116 extending between two of the walls 114 and the top and bottom of the channels 110, 112. As illustrated in FIGS. 4 and 8, both the first side channel 110 and the second side channel 112 include two holes 118 therein aligned with the openings 66 of the rear connection face 64 of the first component 12 when the first component 12 is connected to the second polymeric component 14. Furthermore, both the first side channel 110 and the second side channel 112 include a top groove 120 and a bottom groove 122 for allowing a tool to fit into the first side channel 110 and the second side channel 112 for connecting the fasteners that fit through the holes 118 and the openings 66 to connect the bumper system 10 to the rails 28.

In the illustrated embodiment, the walls 24 forming the energy-absorbing cells 26 extend between the underside of the top wall 80 and a top of the first side channel 110 and the second side channel 112 and between the top of the bottom wall 84 and a bottom of the first side channel 110 and the second side channel 112. Therefore, in the illustrated example, an upper set of the energy-absorbing cells 26 are defined by two of the walls 24, a portion of the front wall of the second polymeric component 14 and either a top of the first side channel 110 or the top of the second side channel 112. Furthermore, a lower set of the energy-absorbing cells 26 are defined by two of the walls 24, a portion of the front wall of the second polymeric component 14 and either a bottom of the first side channel 110 or the bottom of the second side channel 112. The energy-absorbing cells 26 are configured to crush and absorb energy upon a vehicle impact. The illustrated second polymeric component 14 also includes a plurality of energy-absorbing cells 26 in a center section of the second polymeric component. As viewed from the rear in FIG. 8, the center section includes an upper one of the walls 24 extending between the top of the first side channel 110 and the top of the second side channel. Furthermore, the center section includes a lower one of the walls 24 extending between the bottom of the first side channel 110 and the bottom of the second side channel. Moreover, four of the walls 24 extend between the underside of the top wall 80 and the top of the bottom wall 84 to form nine energy-absorbing cells 26 in a grid-like fashion.

In the illustrated bumper system 10 of the present invention, energy-absorbing cells 26 are configured to crush and absorb energy upon a vehicle impact, whereby a need for a separate energy absorber on a face of the bumper system 10 is substantially avoided. Accordingly, as illustrated in FIG. 1, the bumper system 10 and fascia 200 covering the bumper system 10 form a vehicle front end assembly that does not include a separate energy absorber positioned on a face of the second polymeric component 14. Fascia 200 and their connection to vehicles are known to those skilled in the art. Furthermore, the first component is formed from a sheet of material and has a length sufficient to and adapted to extend between the spaced-apart frame rails 28 of the vehicle. The first component 12 characteristically does not have good bending strength in a forward direction as a stand-alone component due to a relatively flat geometry of the first component 12, such that the first component 12 is unable to function as a bumper reinforcement beam by itself. However, the second polymeric component 14 has a polymeric component length about equal to the first component length and is fixedly attached to the first component 12 at multiple locations to form a self-supporting rigid structural bumper reinforcement beam that resists bending.

It is to be understood that variations and modifications can be made on the aforementioned structure without departing from the concepts of the present invention. For example, the second polymeric component 14 could be connected to the first component 12 by first molding a significant portion of the second polymeric component 14 and then molding the second polymeric component 14 over the first component 12 in a second molding step. Additionally, it is contemplated that the flanges of the first component 12 could be crimped over the flanges of the second polymeric component 14 to connect the first component 12 to the second polymeric component 14. Moreover, it is contemplated that an elastic material could be inserted into one or more of the energy-absorbing cells 26 to adjust the energy absorbing characteristics of the bumper system 10. Finally, it is contemplated that the second polymeric component 14 could be molded into different shapes to meet corner styling and corner impact protections, to have airflow passages therethrough, to have integrated lamp housings, to have wire harness attachment clips, to have integrated fascia attachments, to allow for tow hitch and tow hook attachment to the vehicle frame and can have a plastic crush cone over the frame rail(s) for improved air bag actuation tuning.

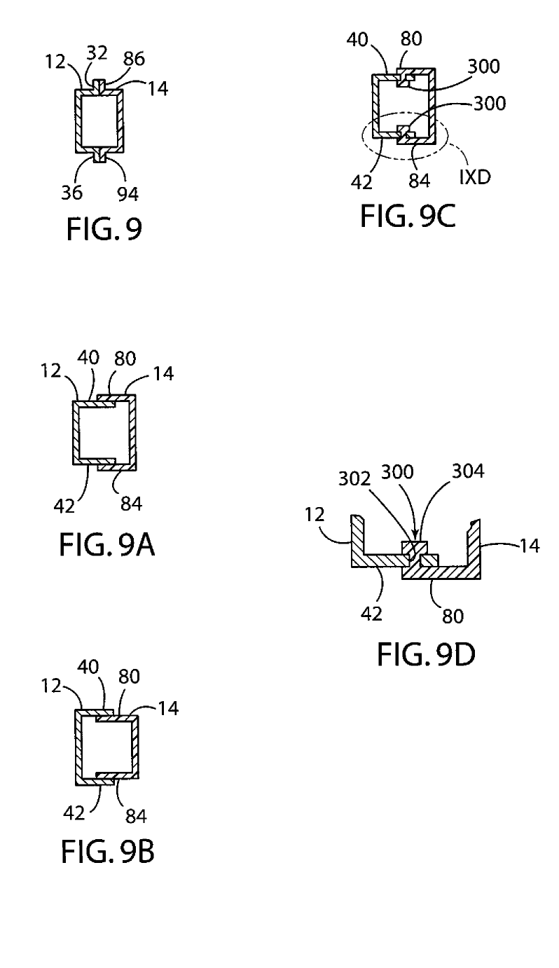

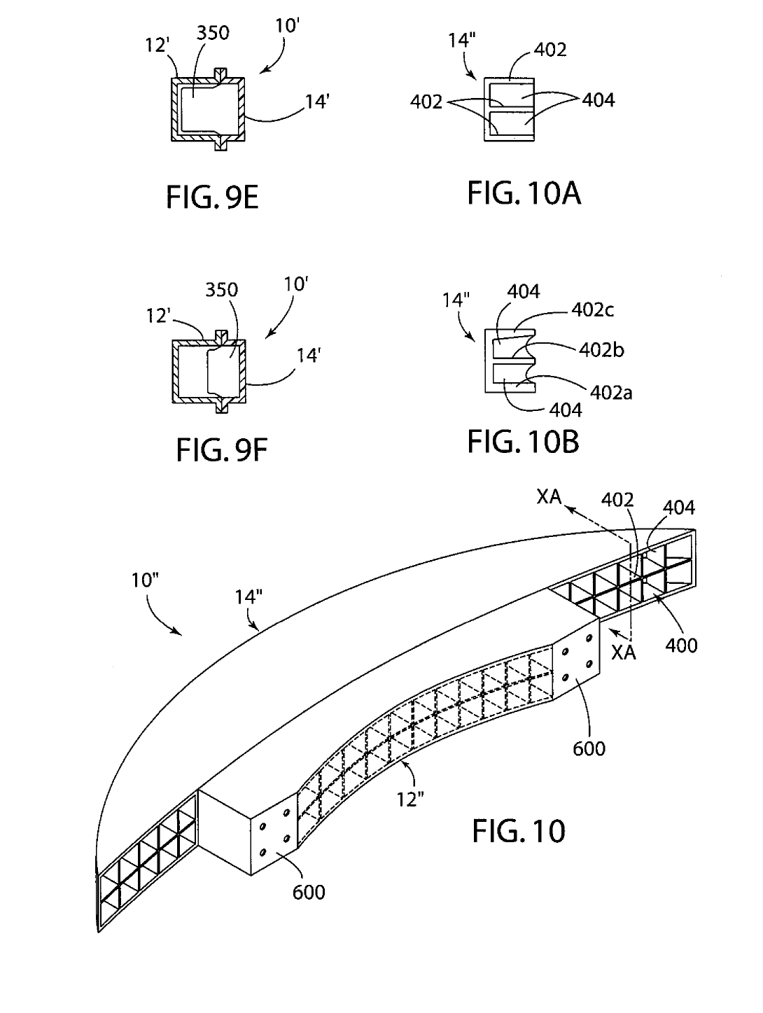

FIGS. 9-9F are vertical cross sections showing various beam embodiments, including various overlapping attachment arrangements for the first component 12 and the second polymeric component 14. FIG. 9 discloses a cross section of the bumper system 10 where the top 32, 86 and bottom 36, 94 abutting attachment flanges of the first and second polymeric components, respectively, extend vertically as discussed above. FIGS. 9A-9C illustrate alternative attachment methods.

FIG. 9A illustrates an arrangement where the first component 12 and the second polymeric component 14 do not include the attachment flanges 32, 36, 86 and 94. Instead, the top wall 80 and bottom wall 84 of the second polymeric component 14 overlie the top surface 40 and the bottom surface 42 of the first component 12, respectively, and are fixedly secured together, such as by mechanical means (which works well due to the different metal and plastic material) or by any other means suitable for the actual materials (e.g. such as by chemical bonding or adhesive methods). Notably, the illustrated arrangement of FIG. 9A presents a shearing force to the attachment during a vehicle impact. However, this is not believed to be problematic due to the fact that the surfaces 40 and 42 of the first component 12 are captured by the second polymeric 14 component such that premature kinking and collapse of the first component 12 of the bumper system 10 is avoided. Furthermore, the second polymeric component 14 includes energy-absorbing cells and interconnected arrays of reinforcement ribs that extend into the concavity of the first component 12, which reduces the shear force (when the cells and arrays engage the interior rear wall of the metal component) and also which help stabilize the top and bottom surface 40 and 42 of the first component 12. FIG. 9B illustrates an arrangement not unlike that shown in FIG. 9A, but with the top wall 80 and bottom wall 84 of the second polymeric component 14 inside of the top surface 40 and the bottom surface 42 of the first component 12, respectively, and fixedly secured together. Notably, this structure is also sufficient to form a structural beam, due to the same reasons given for the beam shown in FIG. 9A.

FIG. 9C illustrates yet another overlapping construction, wherein the top wall 80 and bottom wall 84 of the second polymeric component 14 overlie the top surface 40 and the bottom surface 42 of the first component 12, respectively, (as in the embodiment in FIG. 9B) and at least one protrusion 300 of polymeric material integral with the top wall 80 and the bottom wall 84 of the second polymeric component 14 extends through a corresponding aperture 302 in the top surface 40 and the bottom surface 42 of the first component 12. FIG. 9D shows an enlargement of the attachment structure of FIG. 9C, wherein the integrally formed protrusion of polymeric material 300 is forced through the aperture 302 in the surfaces 40, 42 of the first component 12 and an enlarged head 304 is formed on the protrusion 300 to form a rivet-like permanent attachment. It is contemplated that this arrangement can be made by different methods (e.g., by heat staking). Moreover, where insert molding is used, the material can be flowed through the apertures 302 while the polymeric material is molten and flowable. It is also contemplated that the edges of the polymeric material can be thermally heated (or maintained sufficiently warm) such that the polymeric material can be pressed and thermally flowed through the apertures 302 to bond the second polymeric component 14 to the first component 12.

FIGS. 9E and 9F illustrate a bumper system 10′ where the energy-absorbing cell 350 (e.g., an array of interconnected reinforcement ribs) extends selectively into contact with an interior surface of the first component 12′ (FIG. 9E) and extends selectively short of contact with the interior surface of the first component 12′ (FIG. 9F). For example, the arrangement of FIG. 9F provides a stepped sequential impact absorbing profile during a front impact, while the arrangement of FIG. 9E provides an immediate high increase in energy absorption (i.e., the energy absorbing cell immediately begins to absorb energy upon impact). In one embodiment, a bumper system 10′ could be constructed where the arrangement of FIG. 9E was present over the mounting surfaces, and where the arrangement of FIG. 9F was present over a center of the metal and plastic components. Further, the gap shown in FIG. 9F could be larger in certain longitudinal areas or smaller is certain longitudinal areas (e.g., wherever particular sequential energy absorption was desired). It is also contemplated that the particular ribs can be located in particular spaced arrangements (e.g., FIG. 10A) or can be formed with particular shapes (e.g., FIG. 10B), as discussed below. FIG. 10B shows that the thickness dimension of the ribs can be varied (thicker or thinner) or be made non-uniform (e.g., tapered along their lengths, made shorter or non-uniform in length, etc.) It is contemplated that the components of the bumper system 10′ can be connected using any of the methods described above in connection with FIGS. 9-9D.

FIG. 10 is a perspective view showing a modified bumper system 10″ with stamped rear metal component 12″ and an injection-molded polymeric front component 14″. The polymeric front component 14″ has a plurality of differently-shaped reinforcement rib arrays 400 forming energy absorbing sections 402 with tuned energy absorption characteristics as shown in FIGS. 10A and 10B. FIG. 10A shows that the ribs 402 can be located in particular spaced arrangements, such as with more (or less) intermediate ribs 404, or with intermediate ribs 404 with regular (or irregular) spacing. Also, the ribs 402 can be formed with particular “customized” shapes as illustrated in FIG. 10B. For example, the ribs 402a (thicker) and 402b (thinner) can be made to have thickness dimensions that are varied, or ribs 402c that are made to be non-uniform (tapered at different angles along their lengths), or made to be shorter (or non-uniform) in length. Furthermore, the ribs 404 can extend within the entire area between the ribs 402 as shown in FIG. 10A or can extend in only a portion of the area as shown in FIG. 10B. Notably, changes to the ribs 402 can be made to injection mold dies relatively quickly, such that particular regions of the bumper system 10″ can be readily tuned to have particular desired impact absorption characteristics, even late in the bumper development program. Also, the polymeric material can be more easily varied for particular energy absorption characteristics than varying the metal material. The reason is because fillers (such as glass fibers or the like) can be added to the polymeric material. Alternatively, the polymeric material itself can be purchased with shorter lead times than are required for purchasing a different metal sheet for the metal component.

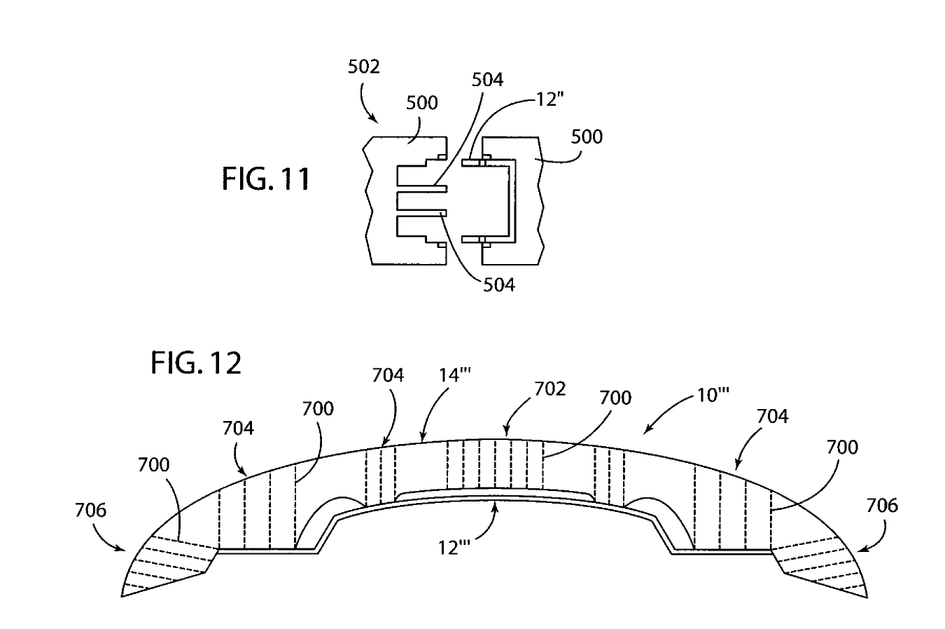

FIG. 11 is a schematic side view of a molding process for making a center portion of the bumper system 10″ of FIG. 10, where the metal component 12″ is positioned within and between the molding dies 500 of an injection mold 502. The process involves insert molding the plastic component 14″ onto the metal component 12″, with molten polymeric material flowing in and around features (e.g. box forming protrusions 504 and apertures in) of the metal component 12″ to integrally form attachments to the metal component 14″. Also, the process of insert molding causes bonding to occur between the plastic and metal materials.

By stamping the metal component 12″ to have coplanar mounting surfaces 600, substantial secondary processing can be avoided. In particular, the need for welding secondary vehicle-frame-engaging mounting brackets to a rear wall of a metal beam can be avoided. Also, by injection molding the plastic component 14″, substantial secondary processing can be avoided. In particular, multiple secondary features can be integrally formed on the plastic component 14″ as part of the molding operation, such as features for mounting wiring and lighting and license plates on the plastic component 14″. Also, all (or at least part of) the attachment structure can be formed integrally on the plastic component 14″.

FIG. 12 is a schematic top view of an alternative modified bumper system 10′″ having a vehicle-engaging metal component 12′″ and an outer plastic component 14′″ attached to the metal component 12′″ to form the bumper system 10′″, with the plastic component 14′″ having interconnected arrays of ribs 700 forming center 702, intermediate 704, and corner-forming 706 crush boxes, each specifically designed for particular crush characteristics at their respective locations along the center, mounts, and corners of the bumper system 10′″.

It is to be understood that such concepts described above are intended to be covered by the following claims unless these claims by their language expressly state otherwise.

We claim:

1. A bumper system for a vehicle having a vehicle frame with vehicle frame rails comprising:
a metal component having a length and opposing ends adapted for attachment to the vehicle frame rails of the vehicle frame; and
a second component engaging a face of the metal component and rigidly attached to the metal component continuously along a common interface or at least at several locations along this interface to form a structural beam with the metal component;
the second component comprising a polymeric material and having sufficient structure to form an integral part of the structural beam but also having interconnected walls extending in a transverse width direction to form energy-absorbing cells configured to crush and absorb energy upon a vehicle impact.

2. The bumper system defined in claim 1, wherein:
the metal component is made from a material having a yield strength of greater than 80 KSI.

3. The bumper system defined in claim 2, wherein:
the metal component is made from a material having a yield strength of greater than 170 KSI.

4. The bumper system defined in claim 1, wherein:
the metal component is formed from a sheet and has a single thickness in a width direction along a majority of the length when in a vehicle-mounted position.

5. The bumper system defined in claim 1, wherein:
the second component includes a top flange and a bottom flange attached to mating abutting surfaces on the metal component.

6. The bumper system defined in claim 5, wherein:
the second component includes a plurality of fasteners connecting the top and bottom flanges to the mating abutting surfaces on the metal component.

7. The bumper system defined in claim 6, wherein:
the plurality of fasteners comprise protrusions extending from the top and bottom flanges.

8. The bumper system defined in claim 7, wherein:
the protrusions are integrally formed as part of the top and bottom flanges; and
the mating abutting surfaces on the metal component include apertures through which the protrusions extend.

9. The bumper system defined in claim 1, wherein:
the second component includes a plurality of integrally-formed protrusions that extend through mating apertures in the metal component.

10. The bumper system defined in claim 9, wherein:
the protrusions include heat staked heads that retain the second component to the metal component.

11. A vehicle end assembly including the bumper system defined in claim 1, and including fascia covering the metal component and the second component, wherein the vehicle front end assembly does not include a separate energy absorber positioned on a face of the second component.

12. The bumper system defined in claim 1, wherein:
the metal component comprises a sheet of metal stamped to form a three-dimensional shape having mounting surfaces integrally formed therein that are configured and adapted for attachment to the vehicle frame rails.

13. The bumper system defined in claim 1, wherein:
the opposing ends of the metal component include coplanar mounting surfaces.

14. The bumper system defined in claim 1, wherein:
the second component includes reinforcement ribs that extend in a fore-aft direction when in a vehicle-mounted position.

15. The bumper system defined in claim 1, wherein:
the second component includes corner-forming end sections that extend in an outboard direction beyond the opposing ends of the metal component.

16. The bumper system defined in claim 1, wherein:
the second component further includes an array of interconnected walls forming a crush box for providing corner impact strength at locations outboard of the opposing ends of the metal component.

17. The bumper system defined in claim 1, wherein:
the second component further includes an array of interconnected walls forming a structural corner and bumper shape at locations outboard of the opposing ends of the metal component.

18. The bumper system defined in claim 1, wherein:
the metal component and second component include front, rear, top and bottom walls that, in at least some locations, are fixedly secured together to form a tubular shape with at least one of the energy-absorbing cells extending into an interior cavity of the tubular shape.

19. A bumper system for a vehicle having a vehicle frame with frame rails comprising:
a first component having a length and opposing ends adapted for attachment to the frame rails of the vehicle frame; and
a second component engaging a face of the first component and rigidly attached to the first component to form a structural beam with the first component;
the second component being molded from material comprising a polymer and having energy-absorbing cells configured to crush and absorb energy upon a vehicle impact, whereby a need for a separate energy absorber on a face of the structural beam is substantially avoided.

20. The bumper system defined in claim 19, wherein:
the second component includes protrusions with thermally-formed heat-staked heads attaching the second component to the first component.

21. The bumper system defined in claim 19, wherein:
the first component is made from a material having a yield strength of greater than 80 KSI.

22. The bumper system defined in claim 21, wherein:
the first component is made from a material having a yield strength of greater than 170 KSI.

23. The bumper system defined in claim 19, wherein:
the first component is comprised of metal and is formed from a sheet.

24. The bumper system defined in claim 19, wherein:
the first component has a greater height dimension and length dimension than depth dimension.

25. The bumper system defined in claim 19, wherein:
the first component is connected to the second component in at least several top and bottom locations along the length.

26. A bumper system for a vehicle having spaced-apart frame rails comprising:
a metal component formed from a sheet of material and having a metal component length sufficient to and adapted to extend between the spaced-apart frame rails of the vehicle, the metal component characteristically not having good bending strength in a forward direction as a stand-alone component due to a relatively flat geometry of the metal component, such that the metal component is unable to function as a bumper reinforcement beam by itself; and
a second component comprising a polymeric material having a polymeric component length about equal to the metal component length and being fixedly attached to the metal component either continuously or at multiple locations to form a self-supporting rigid structural bumper reinforcement beam that resists bending, the second component including a plurality of integrally-formed forwardly-extending energy-absorbing sections configured to crush and absorb energy upon receiving an impact.

27. A method of making a bumper system comprising:
forming a first component of a first material;
forming a second component of a second material, the first material and the second material being different;
engaging the second component with a face of the first component;
rigidly attaching the second component to the first component in at least several locations along the length to form a structural beam with the first component;
providing the second component with sufficient structure to form an integral part of the structural beam but also having interconnected walls extending in the width direction to form energy-absorbing cells configured to crush and absorb energy upon a vehicle impact.

28. The method of claim 27, wherein:
the second material comprises a polymer.

29. The method of claim 27, wherein:
forming the first component comprises stamping a single sheet of metal.
